(19) United States
(12) Patent Application Publication
(10) Pub. No.: US 2007/0005480 A1
(43) Pub. Date: Jan. 4, 2007

(54) Equipment asset appraisal system

(76) Inventors: Thomas P. McDonald, Brookfield, CT (US); Walter T. Van Wyck, Oxford, CT (US); John A. Josko, Vernon Hills, IL (US)

Correspondence Address: BUCKLEY, MASCHOFF, TALWALKAR LLC, 50 LOCUSTAVENUE, NEW CANAAN, CT, 06840, US

(21) Appl. No.: 11/486,402

(22) Filed: Jul. 13, 2006

Related U.S. Application Data
(63) Continuation-in-part of application No. 09/878,685, filed on Jun. 11, 2001.

(51) Int. Cl. G06Q 40/00

(52) U.S. Cl. 705/35; 705/400

(57) ABSTRACT

According to one embodiment, equipment asset information associated with a plurality of equipment assets is stored at a central appraisal controller. A first equipment asset appraiser, of a plurality of equipment asset appraisers, may be associated with equipment asset information for the first equipment appraiser's subset of the equipment assets. Similarly, a first equipment asset party, of a plurality of equipment asset parties, may be associated with equipment asset information for the first equipment party's subset of the equipment assets.

### CROSS-REFERENCE TO RELATED APPLICATIONS

This is a continuation-in-part application of U.S. application Ser. No. 09/878,685, entitled “Method and System for Soliciting, Submitting, and Managing Appraisals” and filed on Jul. 17, 2001. Moreover, the present application claims the benefit of U.S. Provisional Application No. 60/______ entitled “Asset Appraiser” and filed on Jul. 10, 2006. The entire contents of these applications are incorporated herein by reference.

### BACKGROUND

In some situations, a party may require an appraisal of an equipment asset. For example, a bank might need to have industrial machinery appraised before making a loan associated with that machinery. As another example, when a factory or plant is closed some or all of the equipment assets at the facility may need to be appraised by the owner (e.g., in connection with an auction or another type of asset sale).

FIG. 1 illustrates a typical appraisal process. In particular, an equipment asset party 102 (e.g., an owner or service provider hired by the owner) may own one or more equipment assets (e.g., office copiers, furnaces, lasers, or construction equipment). Moreover, the party 102 may hire a professional equipment asset appraiser 104 to evaluate and determine an appropriate value associated with the asset.

The equipment asset appraiser 104 may review the equipment asset and generate notes about the asset. For example, the equipment asset appraiser 104 may store an asset name, an asset location, an asset type, an asset serial number, and/or an asset value in a spreadsheet application (e.g., in an EXCEL® spreadsheet application from MICROSOFT CORP.®). The equipment asset appraiser 104 may also store image information associated with the asset (e.g., an image file representing a digital photograph of the asset). The equipment asset appraiser 104 may also use a word processing application to generate and print an appraisal report 106 for the asset (e.g., using an OFFICE WORD® application from MICROSOFT CORP.®). In some cases, the equipment asset party 104 may need to ensure that the appraisal report complies with one or more industry standards. The standards, however, can periodically change and, as a result, the equipment asset appraiser 104 may need to review and/or revise the reports 106 he or she is generating.

When complete, the equipment asset appraiser 104 may send a hard copy of the appraisal report 106 to the equipment asset party 102. Note that an equipment asset party 102, such as a financial institution or large company, may receive hundreds of such appraisal reports 106. Moreover, the equipment asset party 104 may generate and print hundreds of appraisal reports 106 for various asset owners. As a result, it can be difficult to locate particular appraisal reports 106 and/or to search for certain types of appraisal reports 106 in an efficient manner.

### BRIEF DESCRIPTION OF THE DRAWINGS

FIG. 1 illustrates a typical appraisal process.

FIG. 2 illustrates an appraisal process in accordance with some embodiments of the invention.

FIG. 3 illustrates a method of facilitating appraisals according to some embodiments.

FIG. 4 illustrates how equipment asset information may be associated with parties/owners and appraisers according to some embodiments of the invention.

FIGS. 5 through 12 illustrate appraiser-based displays according to some embodiments of the present invention.

FIG. 13 illustrates a central appraisal controller in accordance with an exemplary embodiment of the invention.

FIG. 14 is a tabular view of a portion of an equipment asset appraiser database in accordance with some embodiments of the present invention.

FIG. 15 is a tabular view of a portion of an equipment asset party database in accordance with some embodiments of the present invention.

FIG. 16 is a tabular view of a portion of an equipment asset report database in accordance with some embodiments of the present invention.

FIG. 17 illustrates a method of facilitating appraisals according to some embodiments.

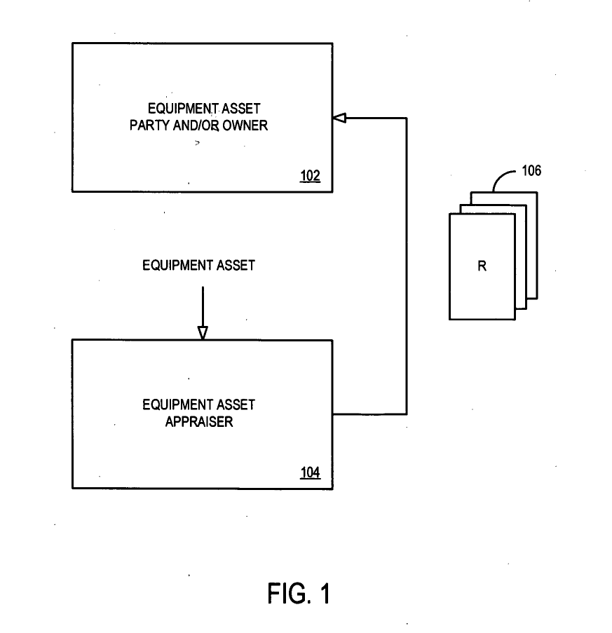

### SUMMARY OF THE INVENTION

According to some embodiments, equipment asset information associated with a plurality of equipment assets is stored at a central appraisal controller. A first equipment asset appraiser, of a plurality of equipment asset appraisers, may be associated with equipment asset information for the first equipment appraiser's subset of the equipment assets. Similarly, a first equipment asset party, of a plurality of equipment asset parties, may be associated with equipment asset information for the first equipment party's subset of the equipment assets.

Other embodiments include: means for receiving, at a central appraisal controller from a plurality of remote devices, equipment asset information associated with a plurality of equipment assets; means for associating, at the central appraisal controller, a first equipment asset appraiser, of a plurality of equipment asset appraisers, with equipment asset information for the first equipment appraiser's subset of the equipment assets; and means for transmitting a digital equipment asset appraisal report to a remote equipment asset party device based at least in part on (i) pre-stored template information and (ii) the received equipment asset information.

In some embodiments, a communication device receives and transmits equipment asset information, and a processor is coupled to the communication device. A storage device in communication with the processor may store instructions adapted to be executed by said processor to: (i) store equipment asset information associated with a plurality of equipment assets, and (ii) associate a first equipment asset appraiser, of a plurality of equipment asset appraisers, with equipment asset information for the first equipment appraiser's subset of the equipment assets.

A technical content of some embodiments of the invention is an efficient facilitation of appraisal report generation and use. With this and other advantages and features that will become hereinafter apparent, a more complete understanding of the nature of the invention can be obtained by referring to the following detailed description and to the drawings appended hereto.

### DETAILED DESCRIPTION

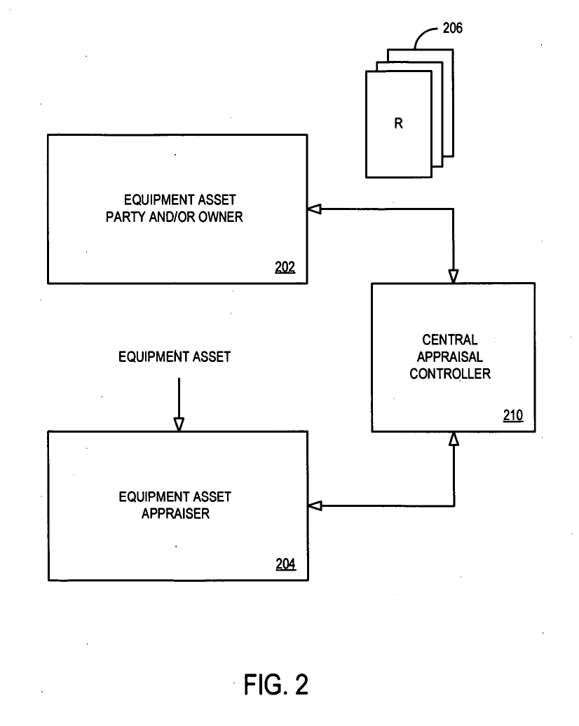

FIG. 2 illustrates an appraisal process in accordance with some embodiments of the invention. As before, an “equipment asset party” 202 may be associated with one or more equipment assets. As used herein, the phrase “equipment asset party” may refer to, for example, an owner of the asset, a financial institution interested in the asset (e.g., a bank that may become involved in a loan or lease of the asset), or a service provider hired by an owner or financial institution. Moreover, the phrase “equipment asset” may refer to, by way of examples only, agriculture equipment (e.g., tractors), construction equipment, office equipment, semiconductor assembly and packaging equipment, lasers, and/or machine tools.

The party 202 may hire a professional equipment asset appraiser 204 to evaluate and determine an appropriate value associated with the asset. For example, the appraiser 204 might be asked to determine a fair market value, a scrap value, a salvage value, or a replacement value associated with the asset.

The equipment asset appraiser 204 may review the equipment asset and generate notes about the asset. For example, the equipment asset appraiser 204 may store an asset name, an asset location, an asset type, an asset serial number, and/or an asset value in a spreadsheet application (e.g., in an EXCEL® spreadsheet application from MICROSOFT CORP.®). The equipment asset appraiser 204 may also store image information associated with the asset (e.g., an image file representing a digital photograph of the asset). The equipment asset appraiser 204 may also use a word processing application to generate notes about the asset (e.g., using an OFFICE WORD® application from MICROSOFT CORP.®).

According to some embodiments of the present invention, the equipment asset appraiser 204 may transmit equipment asset information to a remote central appraisal controller 210. For example, the equipment asset appraiser 204 may use a Personal Computer (PC), a portable computing device such as a Personal Digital Assistant (PDA), a wired or wireless telephone, or any other appropriate storage and/or communication device to provide equipment asset information to the central appraisal controller 210 via a web site and/or a communication network. As used herein, devices (e.g., associated with the equipment asset appraiser 204 and/or central appraisal controller 210) may exchange information, for example, via a communication network such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network (e.g., in accordance with an 802.11 standard), and/or an Internet Protocol (IP) network such as the Internet, an intranet, or an extranet. Note that devices may communicate via one or more such communication networks.

Although a single central appraisal controller 210 is shown in FIG. 2, any number of central appraisal controllers 210 may be included in the system. Similarly, any number of equipment asset appraisers 204 and/or equipment asset parties 202 may be included according to embodiments of the present invention. That is, the central appraisal controller 210 may receive, store, and transmit equipment asset information associated with a number of different equipment asset appraisers 204 and/or equipment asset parties 202.

According to some embodiments, the central appraisal controller 210 may use the equipment asset information to prepare an appraisal report. For example, the equipment asset appraiser 204 might upload information from spreadsheet application, digital photographs, and/or word processing application to the central appraisal controller 210. The central appraisal controller 210 may then, using pre-stored templates, wizards, equipment asset appraiser information and/or equipment asset party information, generate a draft appraisal report 206. Note that the central appraisal controller 210 might help ensure that the report 206 complies with one or more industry standards or regulations. For example, the central appraisal controller 210 might ensure that the report 206 includes language that complies with the Uniform Standards of Professional Appraisal Practice (USPAP) guidelines.

When the report 206 is complete and approved by the equipment asset appraiser 204, he or she may provide an indication to the central appraisal controller 210 (e.g., via a web site). In response to the indication, the central appraisal controller 210 may transmit a digital copy of the appraisal report 206 to the equipment asset party 202. Note that an equipment asset party 202, such as a financial institution or large company, may receive hundreds of such appraisal reports 206. Moreover, the equipment asset party 204 may generate and print hundreds of appraisal reports 206 for various asset owners. Because a copy of the reports 206 may be stored at the central appraisal controller 210, locating particular appraisal reports 206 and/or searching for certain types of appraisal reports 206 may be efficiently facilitated.

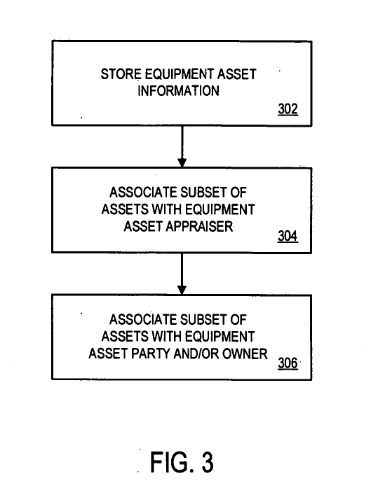

FIG. 3 illustrates a method of facilitating appraisals according to some embodiments. The method may be performed, for example, by the central appraisal controller 210 of FIG. 2. The flow charts described herein do not imply a fixed order to the steps, and embodiments of the present invention may be practiced in any order that is practicable.

At 302, equipment asset information may be stored. For example, a controller may receive equipment asset information from one or more remote equipment asset appraiser devices and store the information. The equipment asset information may be associated with a number of different assets, such as a number of assets located at a factory or industrial plant. The equipment asset information might include, for example, an appraisal project name, an asset type, an asset value, a date (e.g., a date by which an appraisal report is due), an asset location, and/or image information.

The equipment asset information may be received, for example, via a web site. For example, an equipment asset appraiser might access a web site and transmit an identifier associated with a first equipment asset, an identifier associated with him or herself, and an identifier associated with a first equipment asset party (e.g., who currently owns the asset).

A first equipment asset appraiser, of a plurality of equipment asset appraisers, may be associated with equipment asset information for the first equipment appraiser's subset of the equipment assets at 304. For example, one equipment asset appraiser may be associated with one set of assets while another equipment asset appraiser may be associated with another set of assets.

At 306, a first equipment asset party, of a plurality of equipment asset parties, is associated with equipment asset information for the first equipment party's subset of the equipment assets. For example, one equipment asset party may be associated with one set of assets while another equipment asset party may be associated with another set of assets.

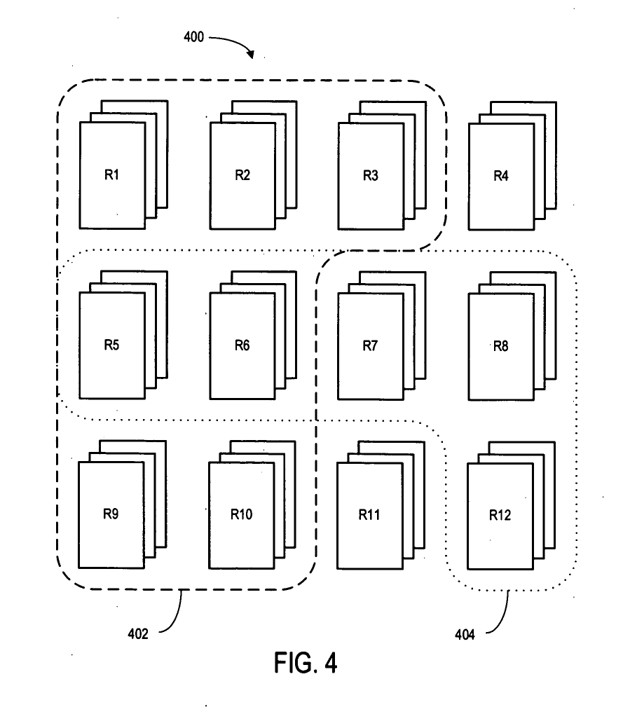

FIG. 4 illustrates how equipment asset information 400 may be associated with parties/owners and appraisers according to some embodiments of the invention. In this case, the equipment asset information 400 is represented by appraisal reports R1 through R12. Note, however, that any other types of equipment asset information may be similarly associated with equipment asset appraisers and/or equipment asset parties. In this case, one set of reports 402 (R1-R3, R5, R6, R9, and R10) is associated with an equipment asset appraiser. For example, that equipment asset appraiser might have provided the information to generate those reports. Note that an equipment asset appraiser might not be allowed to access information outside of his or her set (e.g., the equipment asset appraiser illustrated in FIG. 4 might not be allowed to view or modify R8). Note that other appraisers might be associated with other sets of reports.

The equipment asset information 400 may similarly be associated with equipment asset parties. In FIG. 4, another set of reports 404 (R5-R8 and R12) is associated with an equipment asset party. For example, that equipment asset party might have requested that an appraiser generate those reports. Note that an equipment asset party might not be allowed to access information outside of his or her set (e.g., the equipment asset party illustrated in FIG. 4 might not be allowed to view R3). Note that the equipment appraiser's subset of the equipment assets and the equipment party's subset of the equipment assets are not identical.

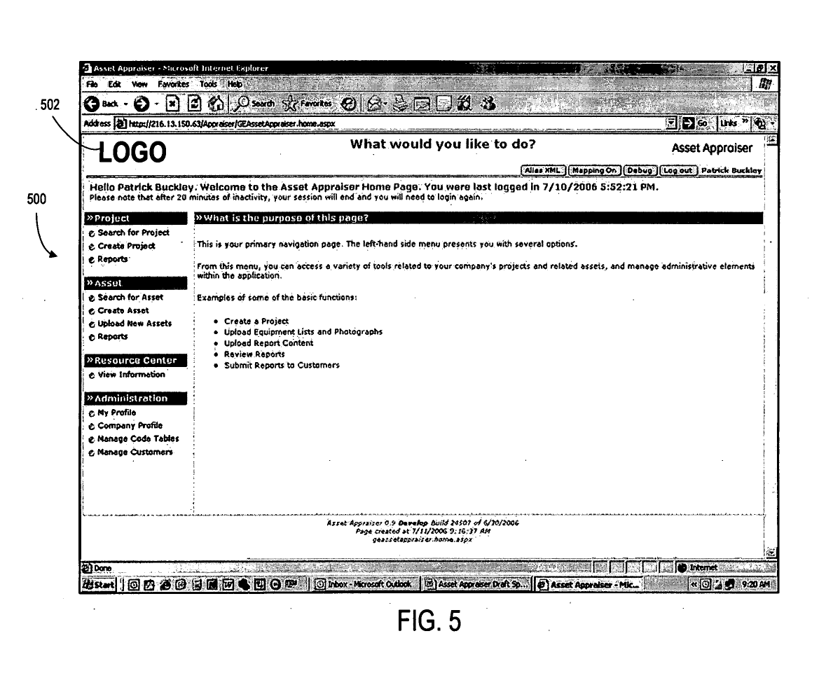

A central appraisal controller might receive equipment asset information from an appraiser via a web site. For example, FIGS. 5 through 12 illustrate appraiser-based displays that might be associated with such a web site according to some embodiments of the present invention. In particular, FIG. 5 illustrates a display that might be presented to an appraiser or asset owner after he or she has provided a username and/or password to a central appraisal controller. From this display, an appraiser might perform project functions (e.g., searching for and/or creating projects and/or reports), asset functions (e.g., searching, creating, and/or uploading asset information), and/or administrative functions (e.g., adjusting information associated with an appraisal company). According to some embodiments, at least a portion 502 of the display 500 may be adjusted based on at least one of: (i) a group of equipment asset appraisers associated with the current equipment asset appraiser or (ii) a group of equipment asset parties associated with the current equipment asset party. For example, one logo might be displayed when one appraiser logs onto the system while another logo is displayed when another appraiser logs on.

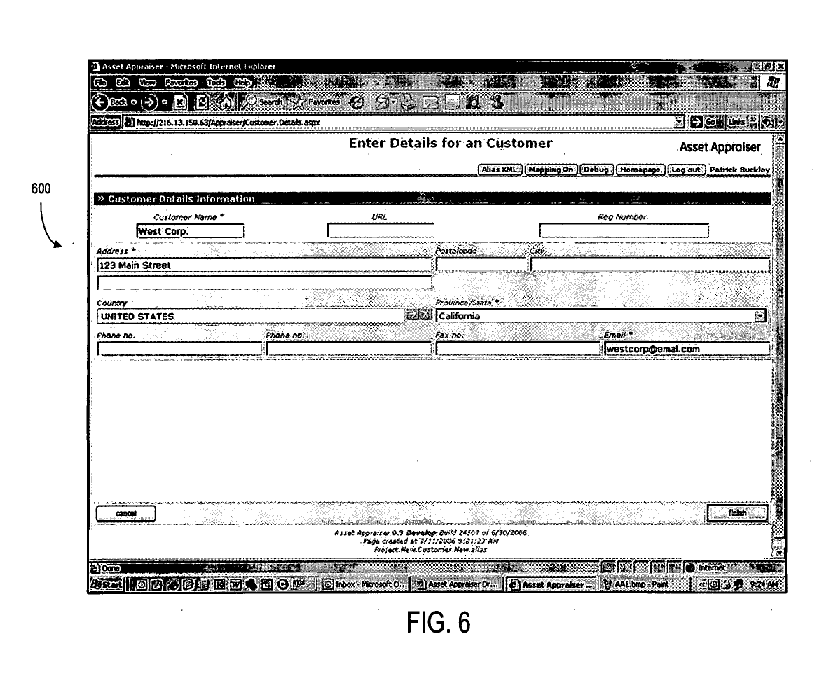

FIG. 6 illustrates a display 600 that might be presented when an appraiser wants to add a new customer to the system. For example, a new customer (e.g., an asset owner who has not hired the appraiser before) might ask the appraiser to generate one or more appraisal reports. In this case, the appraiser might use the display to enter a customer name, postal address, and email address. According to some embodiments, the email address is used by the central appraisal controller to eventually send a digital copy of the appraisal report to the customer.

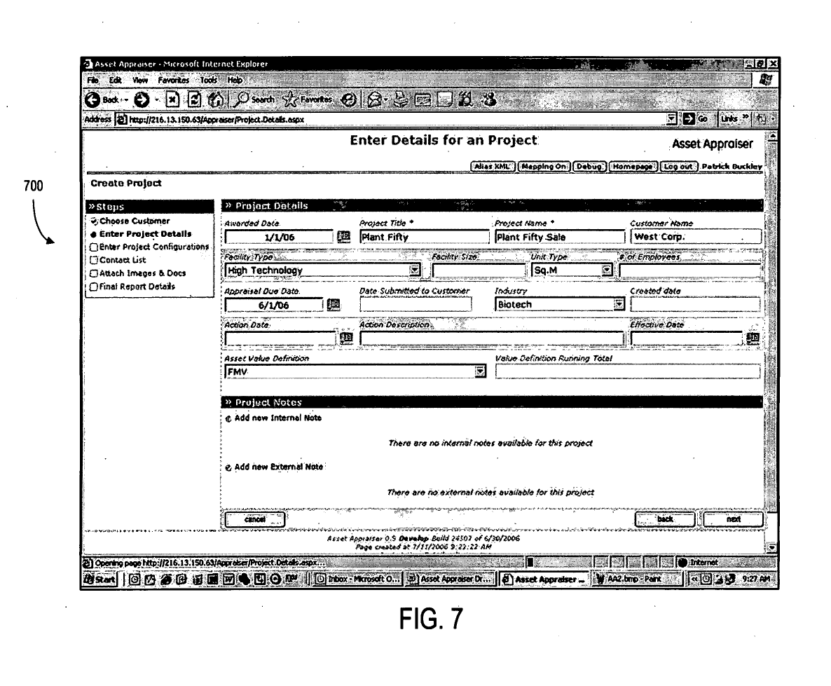

Once the customer information is established, the appraiser may use the display 700 illustrated in FIG. 7 to enter information about a particular project for that customer. For example, the appraiser might enter the date the project began, the date the appraisal report is due, the title of the project, and/or the type of facility associated with the asset or assets.

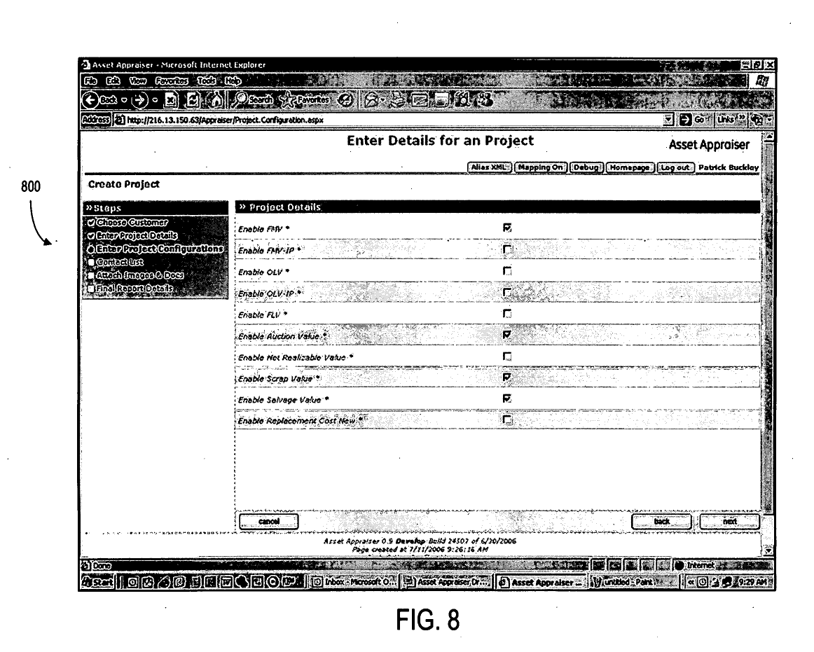

FIG. 8 illustrates a display 800 that an appraiser might use to indicate to the central appraisal controller which types of values need to be included in the final appraisal report. For example, the appraiser might indicate that a fair market value, an auction value, and a salvage value need to be generated for a particular project.

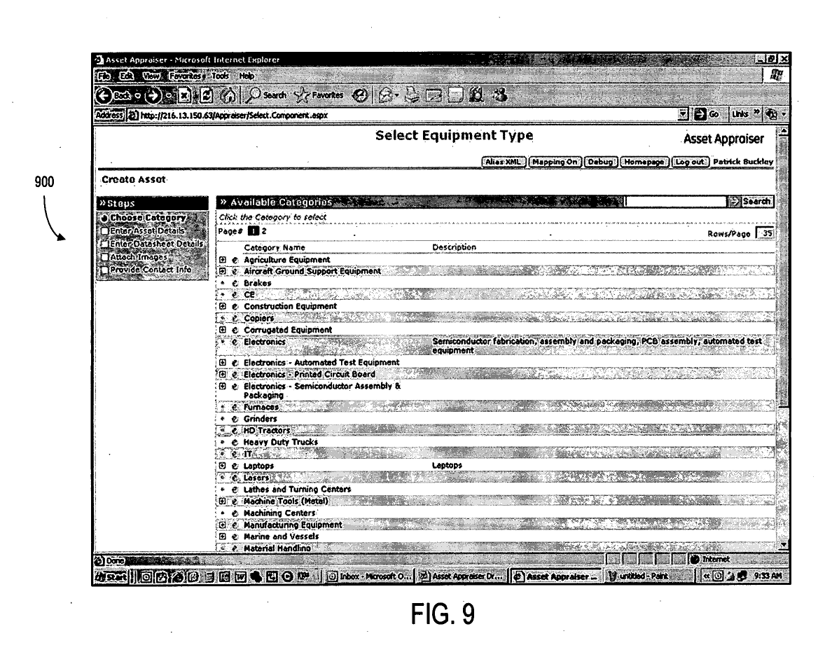

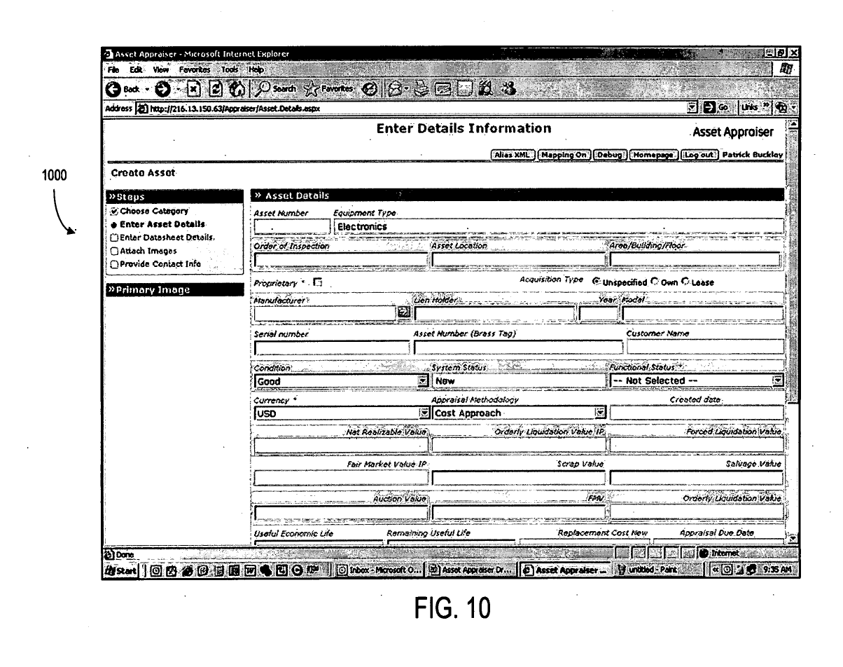

Once a project is established, an appraiser may use a display, such as the one 900 illustrated in FIG. 9, to create an asset associated with the project. For example, the appraiser might first indicate what type of asset is being appraised (e.g., a laptop computer, a furnace, or semiconductor fabrication equipment). More detailed information about the asset might then be provided using the display 1000 of FIG. 10. For example, the appraiser might enter an asset number, an asset location, a manufacturer, an asset year, an asset model, an asset condition (e.g., good or poor), an appraisal methodology, and/or one or more appraised monetary values associated with the asset.

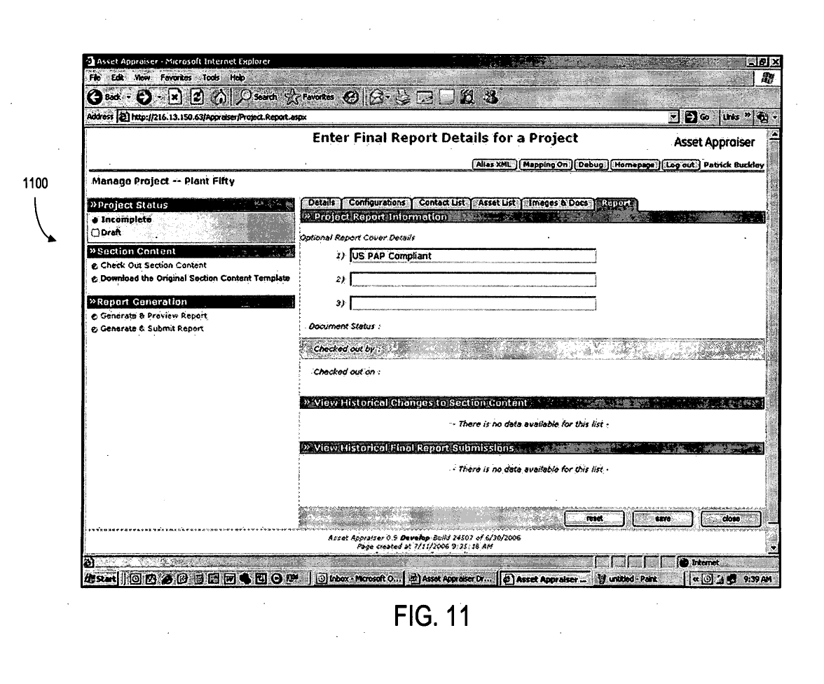

FIG. 11 illustrates a display 1100 that may be used by an appraiser to provide details about an appraisal report. For example, option report over details might be provided by the appraiser. The central appraisal controller can then use those details when a final version of the report is eventually generated. This display 1100 might also be used, for example, to “check out” a copy of a report (e.g., preventing other's from access the same copy of the report) and/or “check in” a copy of a report (e.g., once again letting others access that copy of the report).

According to some embodiments, the display 1100 might also be used to generate a preview appraisal report and/or to indicate to the central appraisal controller that a final version of an appraisal report can be generated and transmitted to an asset owner. The report might include, for example, pre-determined text (e.g., appraisal report “boilerplate”language that complies with USPAP). Such a report might include, for example, a cover letter, an overview of the assignment, the purpose and use of the asset, history and evaluation considerations, the scope of the appraisal, definitions, the effective date of the appraisal, the appraisal methodology, and/or a statement of assumptions and limiting conditions. According to some embodiments of the present invention, image information may be embedded into an appraisal report (e.g., a picture of each asset might be included near other information about that asset).

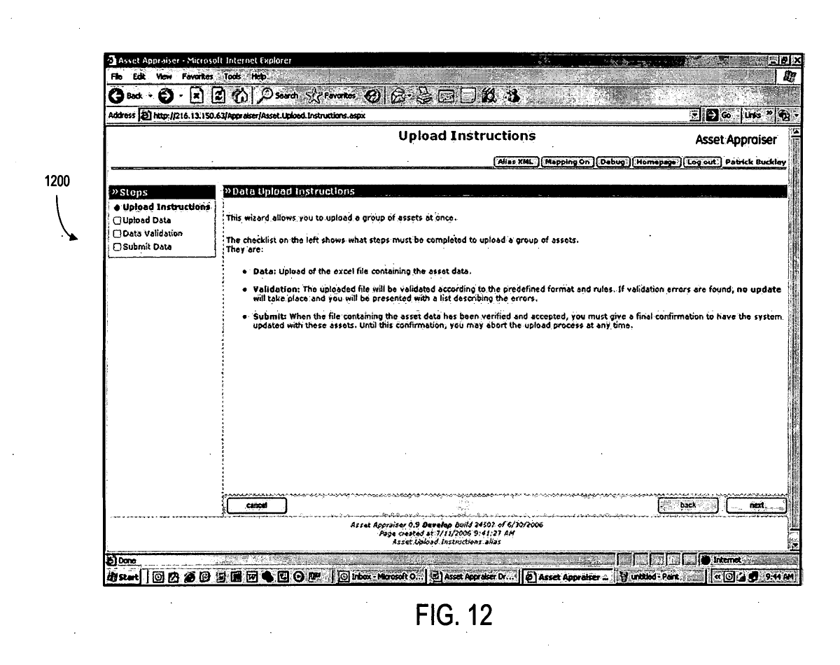

Note that an appraiser might work offline (e.g., when not accessing the web site) to generate the equipment asset information. For example, information might be generated using spreadsheet applications, graphics applications (e.g., for digital photographs), word processing applications (e.g., to generate or modify descriptions of equipment assets), and/or other external applications. According to some embodiments, a central appraisal controller can “upload” information generated by other applications using a display such as the one 1200 illustrated in FIG. 12. Moreover, the central appraisal controller might be able to upload information about a number of different assets. Consider, for example, equipment asset information stored in a spreadsheet. In this case, each column in the spreadsheet might be associated with a different asset parameter (e.g., an asset name, an asset location, and an asset value) while each row in the spreadsheet can be associated with a different asset. In this way, an appraiser can work offline using applications he or she is familiar with and simply upload the information to a the central appraisal controller.

According to some embodiments, an appraiser may use the central appraisal controller to adjust previously provided equipment asset information (e.g., before a final appraisal report is generated). For example, the central appraisal controller might receive, from an equipment asset appraiser, an adjustment to equipment asset information for a particular equipment asset. The central appraisal controller might then verify that the equipment asset appraiser is authorized to adjust equipment asset information for that equipment asset, and, if so, adjust the equipment asset information stored at the central appraisal controller. Similarly, the central appraisal controller might receive a search request from an equipment asset appraiser and provide a search result in response to the search request (e.g., listing all semiconductor assets appraised in the year 2003). Note that an equipment asset party (e.g., an owner of assets) might be allowed to perform similar searches.

Note that equipment asset information might be stored at a central appraisal controller. The central appraisal controller might, according to some embodiments, periodically create back-up copies of the equipment asset information to prevent loss of information. Moreover, the central appraisal controller might determine if, and when, information is allowed to be adjusted or deleted and/or when information should be automatically deleted (e.g., in compliance with appropriate appraisal association ethical standards).

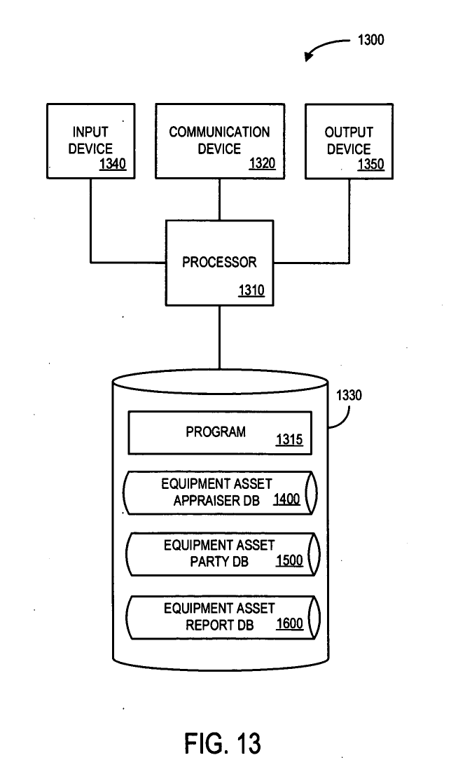

FIG. 13 illustrates a central appraisal controller 1300 that might be descriptive, for example, of the controller 210 illustrated in FIG. 2 in accordance with an exemplary embodiment of the invention. The central appraisal controller 1300 comprises a processor 310, such as one or more INTEL® Pentium® processors, coupled to a communication device 1320 configured to communicate via a communication network (not shown in FIG. 13). The communication device 1320 may be used to communicate, for example, with one or more equipment asset parties 202 and/or equipment asset appraisers 204. According to one embodiment, the communication device 1320 is also used to communicate with other central appraisal controllers 1300.

The processor 1310 is also in communication with an input device 1340. The input device 1340 may comprise, for example, a keyboard, a mouse or other pointing device, and/or a microphone. Such an input device 1340 may be used, for example, to enter administrative information. The processor 1310 is also in communication with an output device 1350. The output device 1350 may comprise, for example, a display screen or printer. Such an output device 1350 may be used, for example, to provide information indicating who modified equipment asset information and/or when it was modified.

The processor 1310 is also in communication with a storage device 1330. The storage device 1330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 1330 stores a program 1315 for controlling the processor 1310. The processor 1310 performs instructions of the program 1315, and thereby operates in accordance with the present invention. For example, the processor 1310 may receive from a plurality of remote devices equipment asset information associated with a plurality of equipment assets. The processor 1310 may then associate a first equipment asset appraiser, of a plurality of equipment asset appraisers, with equipment asset information for the first equipment appraiser's subset of the equipment assets. The processor 1310 may further transmit a digital equipment asset appraisal report to a remote equipment asset party device based at least in part on (i) pre-stored template information and (ii) the received equipment asset information.

According to another embodiment, the processor 1310 may store equipment asset information associated with a plurality of equipment assets. The processor 1310 may then associate a first equipment asset appraiser, of a plurality of equipment asset appraisers, with equipment asset information for the first equipment appraiser's subset of the equipment assets.

As used herein, information may be “received” by or “transmitted” to, for example: (i) the central appraisal controller 1300 from a equipment asset party 202 and/or equipment asset appraiser 204; or (ii) a software application or module within the central appraisal controller 1300 from another software application, module, or any other source.

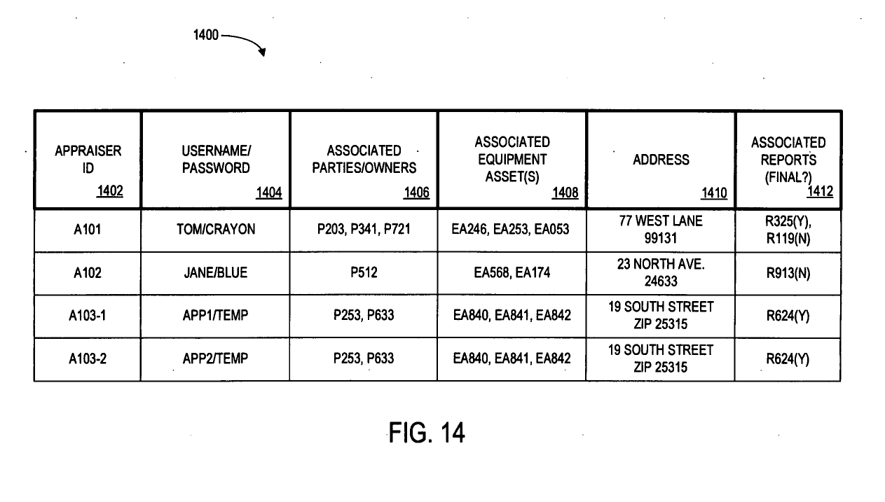

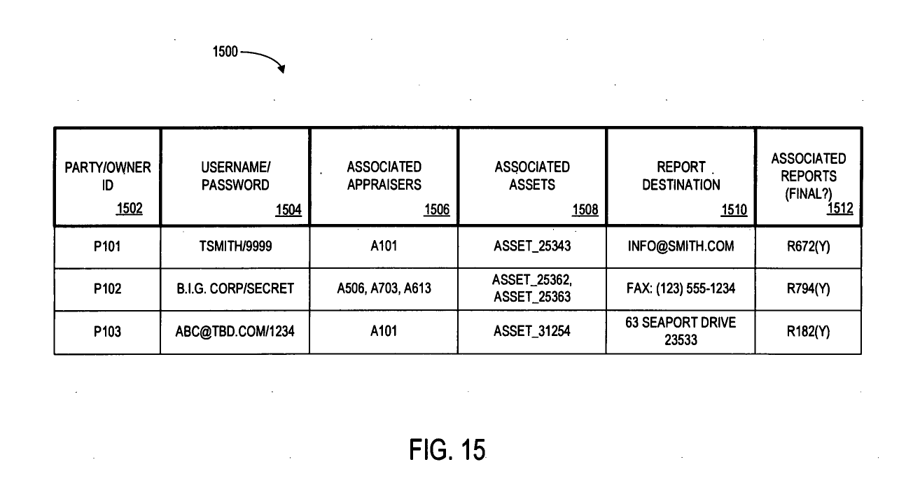

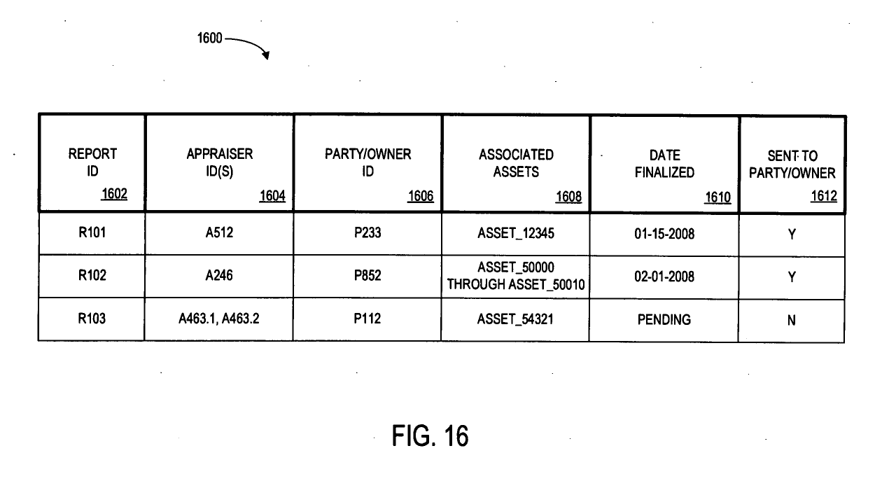

As shown in FIG. 13, the storage device 1330 also stores: an equipment asset appraiser database 1400 (described with respect to FIG. 14); an equipment asset party database 1500 (described with respect to FIG. 15); and an equipment asset report database 1600 (described with respect to FIG. 16). Examples of databases that may be used in connection with the central appraisal controller 1300 will now be described in detail with respect to FIGS. 14 through 16. The illustrations and accompanying descriptions of the databases presented herein are exemplary, and any number of other database arrangements could be employed besides those suggested by the figures.

FIG. 14 is a tabular view of an equipment asset appraiser 1400 database in accordance with some embodiments of the present invention. The table includes entries identifying appraisers that may access the central appraisal controller 1300. The table also defines fields 1402, 1404, 1406, 1408, 1410, 1412 for each of the entries. The fields specify: an appraiser identifier 1402, a username and password 1404, any associated parties or owners 1406, associated equipment assets 1408, an appraiser address 1410, and associated reports 1412. The information in the database 1400 may be created and updated based on information received from equipment asset appraisers.

The appraiser identifier 1402 may be, for example, an alphanumeric code associated with an appraiser and the username and password 1404 may be used by that appraiser to access the central appraisal controller 1300. Note that one equipment asset parties appraiser might be associated at least one other equipment asset appraiser. For example, “A103-1” and “A103-2” might be two appraisers who work for the same appraisal company.

The database 1400 also stores any parties/owners 1406 that are associated with that appraiser (e.g., he or she may have previously worked on projects for those parties or currently being working on a project for them). The associated equipment assets 1408 identify assets that the appraiser has evaluated (or is evaluating). The address 1410 might indicate the appraiser's current mailing address and the associated reports 1412 might indicate which reports he or she has generated, or is currently working on, along with an indication of whether or not each report has been finalized.

FIG. 15 is a tabular view of an equipment asset party 1500 database in accordance with some embodiments of the present invention. The table includes entries identifying parties that may access the central appraisal controller 1300. The table also defines fields 1502, 1504, 1506, 1508, 1510, 1512 for each of the entries. The fields specify: a party/owner identifier 1502, a username and password 1504, any associated appraisers 1506, associated equipment assets 1508, a report destination 1510, and associated reports 1512. The information in the database 1500 may be created and updated based on information received from equipment asset parties.

The party/owner identifier 1502 may be, for example, an alphanumeric code associated with a party and the username and password 1504 may be used by that party to access the central appraisal controller 1300. The database 1500 also stores any appraisers 1506 that are associated with that party (e.g., those appraisers may have previously worked on projects for the party). The associated equipment assets 1508 identify assets associated with the party. The report destination 1510 might indicate who the party would like to receive reports (e.g., via an email address) and the associated reports 1512 might indicate which reports have been received along with an indication of whether each report was final.

FIG. 16 is a tabular view of an equipment asset report 1600 database in accordance with some embodiments of the present invention. The table includes entries identifying reports that have been generated via the central appraisal controller 1300. The table also defines fields 1602, 1604, 1606, 1608, 1610, 1612 for each of the entries. The fields specify: a report identifier 1602, an appraiser identifier 1604, a party/owner identifier 1606, associated equipment assets 1608, a date finalized 1610, and an indication of whether or not the report was sent to the party/owner 1612. The information in the database 1600 may be created and updated by the central appraisal controller 1300.

The report 1602 may be, for example, an alphanumeric code associated with a particular appraisal report. The database 1600 also stores any appraisers 1606 and the party/owner 1606 associated with that report. The associated equipment assets 1608 identify assets appraised in the report. The date finalized 1610 indicates when the appraiser approved the report.

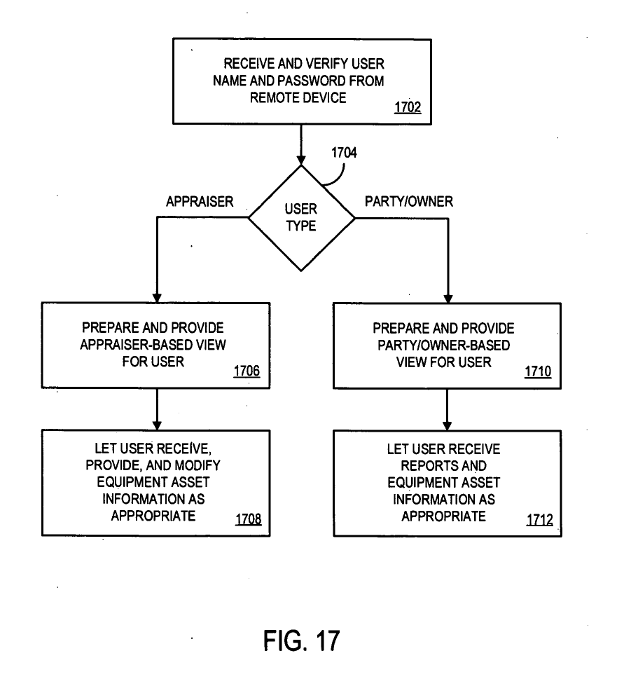

FIG. 17 illustrates a method of facilitating appraisals according to some embodiments. At 1702, a username and password are received from a remote device and verified. The information might be verified, for example, based on the username/password 1404 stored in the equipment asset appraiser database 1400 and/or the username/password 1504 stored in the equipment asset party database 1500.

If the user is valid appraiser at 1704, an appraiser-based view of information is prepared and provided to the user at 1706. The user may then receive, provide, and/or modify equipment asset information as appropriate at 1708. If the user is valid party at 1704, a party-based view of information is prepared and provided to the user at 1710. The user may then receive reports and other equipment asset information as appropriate at 1712.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., an equipment asset database might be stored at the storage device 1330). Moreover, although examples of types of equipment assets have been used, embodiments of the present invention could be used with other types of equipment assets.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A method, comprising:
storing, at a central appraisal controller, equipment asset information associated with a plurality of equipment assets;
associating, at the central appraisal controller, a first equipment asset appraiser, of a plurality of equipment asset appraisers, with equipment asset information for the first equipment appraiser's subset of the equipment assets; and
associating, at the central appraisal controller, a first equipment asset party, of a plurality of equipment asset parties, with equipment asset information for the first equipment party's subset of the equipment assets.

2. The method of claim 1, wherein the equipment asset information is associated with at least one of: (i) a party, (ii) an owner, (iii) a project, (iv) an asset type, (v) an asset value, (vi) a date, (vii) an asset location, or (viii) image information.

3. The method of claim 2, further comprising:
receiving, from the first equipment asset appraiser, equipment asset information associated with a first equipment asset.

4. The method of claim 3, wherein said receiving comprises:
receiving the equipment asset information associated with the first equipment asset from a remote device via a web page.

5. The method of claim 3, wherein said receiving includes:
receiving an identifier associated with the first equipment asset;
receiving an identifier associated with the first equipment asset appraiser; and
receiving an identifier associated with a first equipment asset party.

6. The method of claim 5, wherein said receiving comprises importing information from an external application.

7. The method of claim 6, wherein said importing is associated with a plurality of equipment assets.

8. The method of claim 5, wherein said receiving further includes receiving image information associated with the equipment asset.

9. The method of claim 1, further comprising:
receiving, from the first equipment asset appraiser, an adjustment to equipment asset information for a particular equipment asset;
verifying the first equipment asset appraiser is authorized to adjust equipment asset information for that equipment asset; and
if the first equipment asset appraiser is authorized, adjusting the equipment asset information stored at the central appraisal controller.

10. The method of claim 1, further comprising:
receiving an indication from the first equipment asset appraiser, the indication being associated with a particular equipment asset;
in response to the received indication, generating a digital appraisal report; and
transmitting the digital appraisal report to an equipment asset party associated with that equipment asset.

11. The method of claim 1, further comprising:
receiving a search request from the first equipment asset appraiser; and
providing a search result to the first equipment asset appraiser in response to the search request.

12. The method of claim 1, further comprising:
receiving a search request from the first equipment asset party; and
providing a search result to the first equipment asset party in response to the search request.

13. The method of claim 1, wherein the first equipment appraiser's subset of the equipment assets and the first equipment party's subset of the equipment assets are not identical.

14. The method of claim 1, further comprising:
associating at least one other equipment asset appraiser with the first equipment asset appraiser.

15. The method of claim 1, further comprising:
verifying that at least a portion of the equipment asset information associated with a particular equipment asset complies with an industrial standard.

16. The method of claim 1, further comprising:
determining when equipment asset information associated with a particular equipment asset should be deleted.

17. The method of claim 1, further comprising:
adjusting a display of information based on at least one of: (i) a group of equipment asset appraisers associated with the first equipment asset appraiser or (ii) a group of equipment asset parties associated with the first equipment asset party.

18. A central appraisal controller, comprising:
a communication device to receive and transmit equipment asset information;
a processor coupled to the communication device; and
a storage device in communication with said processor and storing instructions adapted to be executed by said processor to:
store equipment asset information associated with a plurality of equipment assets, and
associate a first equipment asset appraiser, of a plurality of equipment asset appraisers, with equipment asset information for the first equipment appraiser's subset of the equipment assets.

19. The controller of claim 18, further comprising:
a database to store at least one of: (i) equipment asset information, (ii) equipment asset appraiser information, (iii) equipment asset party information, or (iv) report information.

20. A computer readable medium storing instructions adapted to be executed by a processor to perform a method of facilitating asset appraisal, said method comprising:
receiving, at a central appraisal controller from a plurality of remote devices, equipment asset information associated with a plurality of equipment assets;
associating, at the central appraisal controller, a first equipment asset appraiser, of a plurality of equipment asset appraisers, with equipment asset information for the first equipment appraiser's subset of the equipment assets; and
transmitting a digital equipment asset appraisal report to a remote equipment asset party device based at least in part on (i) pre-stored template information and (ii) the received equipment asset information.
